(19) United States
(12) Patent Application Publication
(10) Pub. No.: US 2026/0311136 A1
(43) Pub. Date: Oct. 8, 2026

(54) NEURAL NETWORK-BASED SYSTEMS AND METHODS FOR PERSONALIZED VOCATIONAL GUIDANCE USING DYNAMIC APTITUDE-BASED CLUSTERING

(71) Applicant: YouScience, LLC, American Fork, UT (US)

(72) Inventors: John Philip Hardin, Brentwood, TN (US); Thomas Bertoli Cunningham, American Fork, UT (US); Derek Damian Curtis, American Fork, UT (US); James Matthew Barkley, American Fork, UT (US); Bridget Leigh Flowers, American Fork, UT (US); Bradley Jay Barton, American Fork, UT (US); Pablo Ifrán, Montevideo (UY); Maria Virginia Rodríguez Rocha, Montevideo (UY); Joaquin Manuel Olego Tiscornia, Montevideo (UY)

(73) Assignee: YouScience, LLC, American Fork, UT (US)

(21) Appl. No.: 19/098,557

(22) Filed: Apr. 2, 2025

(51) Int. Cl. G06Q 10/1053; G06Q 10/0631; G06Q 50/20

(52) U.S. Cl. CPC G06Q 10/1053; G06Q 10/063112; G06Q 50/205

(57) ABSTRACT

A predictive system and method for matching users to careers and/or career groupings comprises a model training stage wherein training input data is collected for various training users, the training data comprising aptitude testing performance values and career interest values. Models are trained to generate aptitude data clusters which correlate to respective careers, preferably minimizing number of aptitude tests required while providing sufficient correlation. A current user assessment stage includes collecting first aptitude and interest input data for current users, identifying a cluster of training input data corresponding to similarly performing training users, and selecting additional aptitude tests to provide requisite career correlation while minimizing the number of tests required, or satisfying a threshold number of tests. A user-specific data set is generated representing correlations for the input aptitude and interest data with respect to one or more careers, and in some embodiments with recommended pathways correlating to such careers.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE INVENTION

The present disclosure relates generally to systems and methods for providing endpoint users with personalized vocational guidance based on measured aptitudes and skills, further in view of user-identified career interests, and for objectively matching the endpoint users to careers and/or educational/career pathways.

### BACKGROUND

Methods for measuring examinee aptitudes in various intellectual and/or vocational fields for the purpose of directing examinees towards one or more potential career pathways are conventionally known and in use for students, educators, and prospective employers. However, such methods have traditionally relied heavily on subjective user input, and/or typically rely on underlying research, testing, and formulas for characterizing test results which are static and substantially universal in application, rather than being flexibly responsive to changes in, e.g., demographics.

In addition, student time in an academic setting is at a premium, and many conventional methods require lengthy test periods to be effective. Conversely, methods that rely on short or abbreviated testing periods may be of limited use, due to poor accuracy or comprehensiveness.

Accordingly, the present inventors sought to shorten the amount of aptitude assessment time required before generating career recommendations. The primary method employed in the past was to eliminate certain aptitude measures whose elimination did not materially impair the integrity of the resulting career recommendations. However, this method of elimination has inherent limits, stemming at least in part from the static, fixed order set of aptitudes present in the conventional systems. While aptitude testing time was reduced from 2.5 hours to 1.5 hours by making various aptitude measures optional, it was unfortunately found that the elimination of virtually any combination of aptitude measures as required to reduce testing time by 30 minutes caused a material degradation in the integrity of the career recommendations. However, this also assumed that we had to use a static, fixed order set of aptitudes.

Accordingly, there is a need for objective, aptitude-based vocational guidance methods which are capable of learning over time how to best correlate with careers, which can adjust over time to changes in such correlations or even to changing demographics in the field or with respect to the end users themselves, and which can be administered to test takers in a reduced time frame, without degrading the accuracy of any career recommendation results provided by the vocational guidance methods.

### SUMMARY

Aspects of the present disclosure provide a vocational guidance method that combines abbreviated test times, in some cases sixty minutes or less, with little to no loss of accuracy and/or utility of the vocational suggestions. According to some aspects of the present disclosure, the vocational guidance methods can comprise a screening test followed by an adaptive test that lacks the conventional constraint of relying on a static, fixed order aptitude assessment, but instead varies based on examinee responses to the screening test. Based on iteratively trained and validated models for assessment, scoring, and predictive capabilities, systems and methods as disclosed herein can deliver a “personalized” set of aptitude measures driven by real-time scoring where the results of an aptitude measure or set of aptitude measures influence the next set of aptitude measures a user may receive. For example, by applying artificial intelligence GPT technology, existing data and other acquired data may be leveraged to select groups of aptitude measures that will yield the most accurate results based on a user's results from an initial core group of aptitude measures. Once the user completes this “personalized” battery of aptitudes, systems and methods as disclosed herein may for example generate fit scores unique to the user's combination of aptitude measures, interest results, and careers.

In an exemplary embodiment of a predictive method for matching users to careers and/or career groupings according to the present disclosure, the method includes a model training stage and a current user assessment stage. During the model training stage, the exemplary method includes collecting training input data comprising, for each of a plurality of training users, a plurality of aptitude testing performance values, and training user input corresponding to interest values for one or more of a plurality of careers. The one or more neural network-based models are trained to generate clusters of the input data, including at least aptitude testing performance value combinations, which correlate to respective careers, wherein training parameters are selected for each combination corresponding to a respective number of aptitude testing performance values and a respective degree of correlation. During the current user assessment stage, the exemplary method includes collecting current input data comprising, for a current user, a plurality of aptitude testing performance values for a corresponding first set of aptitude tests, and current user input corresponding to interest values for one or more of the plurality of careers. By reference to the trained model, a cluster of training input data are identified corresponding to similarly performing training users with respect to the collected current input data, selecting a second set of aptitude tests are selected based on a predicted combination of aptitude tests optimizing a minimal number of aptitude testing performance values and/or maximizing a respective degree of correlation to respective careers. Further current input data are collected comprising, for the current user, aptitude testing performance values for the corresponding second set of aptitude tests, and generating an aggregate set of aptitude testing performance values. A user-specific data set is generated representing correlations for the collected current input data and further current input data with respect to one or more of the plurality of careers.

In one exemplary aspect according to the above-referenced embodiment and optionally one or more of the aspects described herein, the method may further comprise, during the current user assessment stage and upon identifying a first cluster of training input data corresponding to similarly performing training users with respect to the collected current input data, further identifying a second cluster of training input data for micro-segmentation within the first cluster, and selecting the second set of aptitude tests based at least in part on modeled correlations associated with the identified second cluster.

In another exemplary aspect according to the above-referenced embodiment and optionally one or more of the aspects described herein, the method may further comprise determining whether to recluster the current user based on the further current input data and a fit of the further current input data with respect to predicted further current input data based on historical data for training users in the same cluster as the current user.

In another exemplary aspect according to the above-referenced embodiment and optionally one or more of the aspects described herein, the method may further comprise monitoring demographic data for the current user, and dynamically determining over time whether to recluster the current user based on changes in the demographic data.

In another exemplary aspect according to the above-referenced embodiment and optionally one or more of the aspects described herein, the method may further comprise, during the current user assessment stage and upon generating the aggregate set of aptitude testing performance values, predicting aptitude performance values for the current user with respect to one or more untested aptitudes, based at least in part on historical aptitude testing performance values for training users in the same cluster as the current user, wherein the generated aggregate set of aptitude testing performance values comprises the predicted aptitude performance values.

In another exemplary aspect according to the above-referenced embodiment and optionally one or more of the aspects described herein, the method may further comprise dynamically determining over time whether to regenerate the user-specific data set based on changes in demographic data associated with the user.

In another exemplary aspect according to the above-referenced embodiment and optionally one or more of the aspects described herein, the method may further comprise training at least one of the one or more neural network-based models to correlate pathways with respect to careers, and further generating the user-specific data set to represent correlations to one or more pathways with respect to the one or more of the plurality of careers, based at least in part on current user-specific demographic data and pathway-specific demographic data.

In another exemplary aspect according to the above-referenced embodiment and optionally one or more of the aspects described herein, at least the collected current input data and the further current input data associated with the current user may be provided for model feedback as another training user.

In another exemplary aspect according to the above-referenced embodiment and optionally one or more of the aspects described herein, the method may further comprise dynamically obtaining career-based feedback associated with one or more of the training users over time, and iteratively training the model to generate the clusters further accounting for the career-based feedback.

In another exemplary aspect according to the above-referenced embodiment and optionally one or more of the aspects described herein, the second set of aptitude tests may be selected based at least in part on a specified maximum number of aptitude tests or a specified maximum amount of test time for obtaining the aptitude testing performance values.

In another exemplary embodiment, a predictive system is provided for matching users to careers and/or career groupings according to the present disclosure, wherein one or more processors are configured to direct the performance of steps according to the above-referenced method embodiment, and optionally one or more of the aspects thereof.

The foregoing and other objects, features and advantages of the present disclosure will become more apparent from the following detailed description, which proceeds with reference to the accompanying figures.

### BRIEF DESCRIPTION OF THE SEVERAL VIEWS OF THE DRAWINGS

FIG. 1 is a block diagram representing an embodiment of a system according to the present disclosure for providing vocational guidance.

FIG. 2 is a flowchart representing an embodiment of a method according to the present disclosure for providing vocational guidance.

FIG. 3 is a flowchart representing an exemplary variant or subset of the method of FIG. 2, comprising database extraction for calculation of program fit scores independent of a career fit score calculation system.

FIG. 4 is a flowchart representing an exemplary variant or subset of the method of FIG. 2, comprising a vocational guidance method including both empirical and predicted user results.

FIG. 5 is a flowchart representing an exemplary variant or subset of the method of FIG. 4, in which a screening test is prepared.

FIG. 6 is a flowchart representing an exemplary variant or subset of the method of FIG. 4, in which historical data is separated into clusters and an adaptive test is prepared.

FIG. 7 is a flowchart representing an embodiment of a vocational guidance method according to another aspect of the present disclosure.

FIG. 8 is a flowchart representing an exemplary process flow of an examinee using the vocational guidance method of FIG. 4.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The implementations disclosed in the above drawings and the following detailed description are not intended to be exhaustive or to limit the present disclosure to these implementations. Any alterations and further modifications to the described devices, systems, methods, and any further application of the principles of the present disclosure are fully contemplated as would normally occur to one skilled in the art to which the disclosure relates. In particular, it is fully contemplated that the features, components, steps, or a combination thereof described with respect to one example may be combined with the features, components, steps, or a combination thereof described with respect to other examples of the present disclosure.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps may be described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

In general, a multi-stage process according to various embodiments of a system or method of the present disclosure may include a model training stage (as further described below) for iteratively developing models over time to best correlate input combinations with respective occupations, careers, pathways, and the like, as well as a user assessment stage for providing personalized predictions, recommendations, and the like with respect to occupations, careers, pathways, etc.

The term “occupation” may refer to one or more professional or non-professional roles, work, positions, posts, vocations, or trades, each and any generally associated with a term of employment or pre-employment. For example, “occupation” may at times refer to a specific position within a line of work (e.g., “cardiologist”), broad employment definitions (e.g., “doctor,” “heart surgeon”), or pre-employment training (e.g., “medical student,” “intern”). The term “career” may at times be generally interchangeable with the term “occupation” in accordance with the context of its use herein and at times may generally refer to a series or group of related occupations. The term “career path” or “pathway” may refer to one or more occupations associated with a generally chronological and/or typical progression of employment (e.g., premed college student>medical student>intern>physician resident>physician fellow>attending physician>practicing physician>senior practicing physician>hospital director), and/or one or more targeted programs associated with a projected chronological and/or typical progression in view of a desired career objective. The term “career” may still further represent one or more careers, for example in the context of a “career cluster” as may be appreciated by one of skill in the art, and as may be recommended collectively in association with a career fit score as disclosed herein to provide general vocational guidance as opposed to individual career-specific guidance.

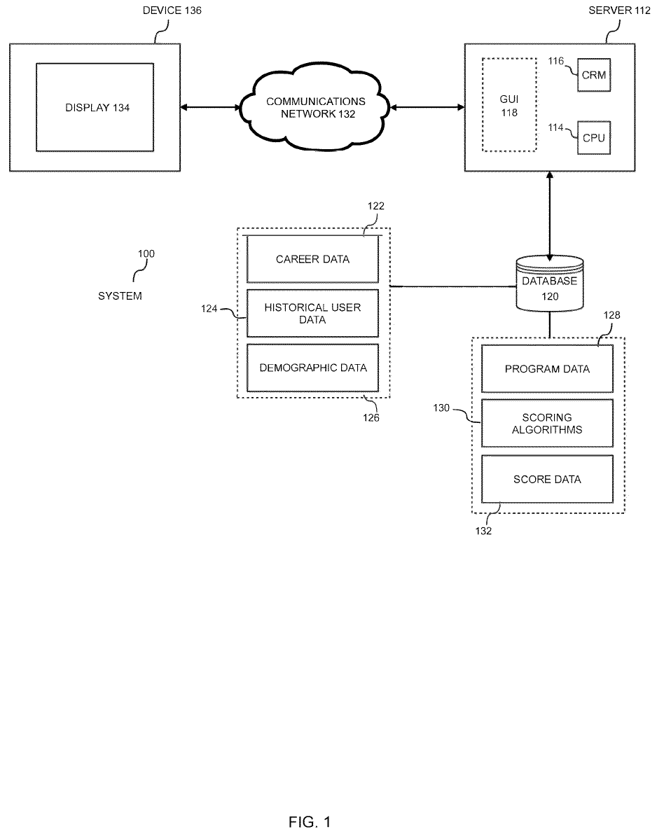

Referring generally now to FIGS. 1-8, exemplary embodiments of systems and methods according to the present disclosure may now be described. Where the various figures may describe embodiments sharing various common elements and features with other embodiments, similar elements and features are given the same reference numerals and redundant description thereof may be omitted below.

Referring to FIG. 1, a system 100 according to the present disclosure may include one or more first computing devices 112, for example data centers, servers, or the like, each independently configured or otherwise functionally linked to execute one or more methods as described below. The first computing devices 112 as represented in FIG. 1 may include one or more processors 114 and computer readable media 116 having computer program products including various software engines residing thereon, and functionally linked, selectively or continuously, to data storage 120 associated with the first computing devices 112. The software engines are executable by the processor 114 to direct operations as described herein, including the generation of a user interface 118 that may be accessible by various users via displays 134 associated with respective second computing devices 136 via a communications network 132. Where multiple processors 114 are implemented by a first computing device 112 or network of computing devices 112, one or more of the processors 114 may be local, remote, or a mixture thereof. One or more of the processors 114 may share information via wired, wireless, or a mixture of communications means. One or more processors 114 may fixedly or dynamically assign portions of computation with respect to functions as described herein to one or more other processors of the computing device 112 or network of computing devices 112.

The term “processor” as used herein may refer to at least general-purpose or specific-purpose processing devices and/or logic as may be understood by one of skill in the art, including but not limited to a microprocessor, microcontroller, state machine, central processing unit, graphical processing unit, neural processing unit, artificial intelligence chips, and the like, including combinations thereof.

The components of a system 100 as disclosed herein, and more particularly a computing device 112, 136 and associated program modules or the like as configured to execute steps in a method as further described below, may generally be programmed to request, extract, receive, translate, ingest, and otherwise process data from input/output devices, user interfaces, sensors, remote/third party devices, or the like via manual upload, application program interfaces, etc. Types and formats of such data may be well understood by those of skill in the art, and user interfaces may for example be dynamically generated based on the type and/or format of data, a status of a user interacting with the respective computing unit via the interface, a type of computing device associated with the user, etc. The term “user interface” as used herein may unless otherwise stated include any input-output module with respect to a first computing device (e.g., hosted server) including but not limited to web portals, such as individual web pages or those collectively defining a hosted website, mobile device applications, telephony interfaces such as interactive voice response (IVR), and the like. Such interfaces may in a broader sense include pop-ups or links to third party websites for the purpose of further accessing and/or integrating associated materials, data, or program functions via the hosted system and in accordance with methods of the present invention.

The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISPs), and intermediate communication interfaces.

The server 112 may further have residing thereon, or otherwise be functionally linked to, a data storage network 120 including for example one or more databases or other data repositories effective to store information retrievable by the server's software engines as required for operation of a method of the present disclosure. The information may include occupation data 122, historical user data 124, demographic data 126 (e.g., user demographic data, career demographic data, pathway demographic data), and the like as further implemented in accordance with method steps as described below, but additional data may of course be stored and implemented for other purposes without limitation on the scope of the present disclosure. In one embodiment, the data storage network may comprise Amazon cloud products such as, for example the Relational Database Service (RDS) or Simple Storage Service (S3) products.

The information of the data storage network 120 may further include program data 128, which may further comprise one or more program names, correlated values between the measures of aptitude and interests and particular careers, and other parameters, weightings, demographic data, or the like as further contributing to the correlations; scoring algorithms 130; and score data 132 such as user fit scores and associated metadata.

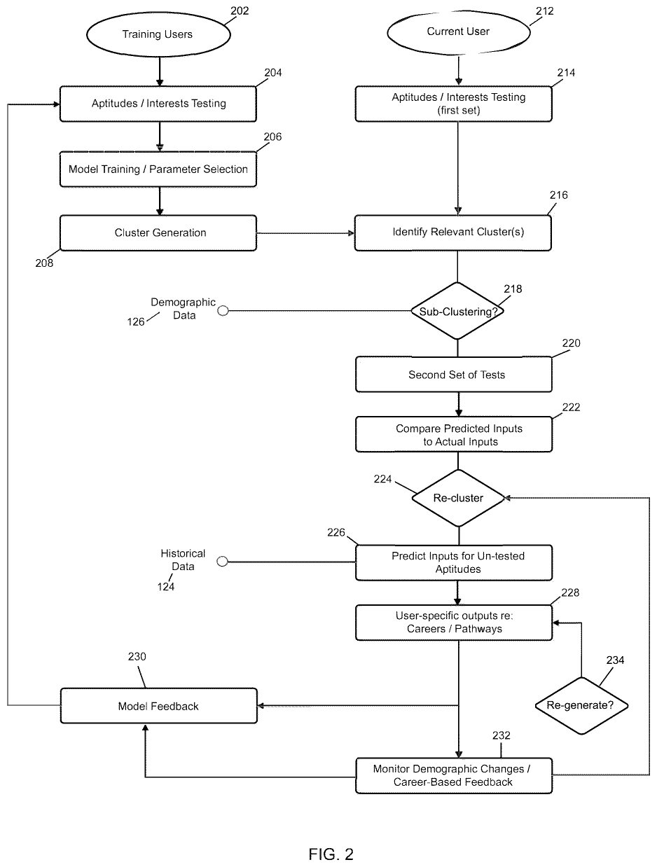

Referring next to FIG. 2, an exemplary method 200 as disclosed herein may include a model training stage and a user assessment stage. The illustrated embodiment of a method 200 may for example be performed through implementation of the system 100 of FIG. 1, but is not limited to the same unless otherwise specifically noted. Various types of machine learning models and corresponding algorithms may be implemented with embodiments of a system and method as disclosed herein.

One of skill in the art may further appreciate that alternative embodiments of the method 200 (and others as further disclosed herein) may include fewer or additional steps, and that certain disclosed steps may for example be performed in different chronological order or simultaneously. Generally stated, various operations, steps, or algorithms as described herein can be embodied directly in hardware, in a computer program product such as a software module executed by a processor, or in a combination of the two. The computer program product can reside in RAM memory, flash memory, ROM memory, EPROM memory, EEPROM memory, registers, hard disk, a removable disk, or any other form of computer-readable medium known in the art. An exemplary computer-readable medium can be coupled to the processor such that the processor can read information from, and write information to, the memory/storage medium. In the alternative, the medium can be integral to the processor, the processor and the medium can reside as discrete components in a user terminal, or the like.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps are described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

In an embodiment, the model training stage utilizes inputs associated with a group of training users 202, for example comprising results from an array of aptitudes tests and user inputs corresponding to respective interests of the various training users for one or more of an array of careers 204. The model training stage may further include training one or more neural network-based models 206 to generate clusters of the input data 208, including at least aptitude testing performance value combinations, which correlate to respective careers. In an embodiment, at least one of the one or more neural network-based models may be trained to correlate pathways with respect to careers, and further generating the user-specific data set to represent correlations to one or more pathways with respect to the one or more of the plurality of careers, based at least in part on current user-specific demographic data and pathway-specific demographic data.

During the current user assessment stage, input data may be collected for a current user 212, for example as part of a “screening test” as further described herein, including a plurality of aptitude testing performance values for a corresponding first set of aptitude tests 214, and current user input corresponding to interest values for one or more of the plurality of careers. By reference to the previously trained model, the method 200 may further include identifying a cluster of training input data 216 corresponding to similarly performing training users with respect to the collected current input data, and selecting a second set of aptitude tests 220 (for example as further described herein as an “adaptive test”) based on a predicted combination of aptitude tests. The selection of the second set of tests may be performed, e.g., to optimize a minimal number of aptitude testing performance values, maximize a respective degree of correlation to respective careers, and/or other optimization parameters as may be relevant for the particular host, administrator, user, etc. As another example, the second set of aptitude tests may be selected based at least in part on a specified maximum number of aptitude tests or a specified maximum amount of test time for obtaining the aptitude testing performance values.

In an embodiment, upon identifying a first cluster of training input data corresponding to similarly performing training users with respect to the collected current input data, the method 200 may include further identifying a second cluster (e.g., sub-cluster) 218 of training input data for micro-segmentation within the first cluster, such that the second set of aptitude tests may be selected based at least in part on modeled correlations associated with the identified second cluster.

The method 200 may continue by collecting further current input data with respect to the current user, for example comprising aptitude testing performance values for the corresponding second set of aptitude tests, and generating an aggregate set of aptitude testing performance values. A user-specific (e.g., personalized) data set 228, in some embodiments including fit scores, pathways, and/or the like, may be generated representing correlations for the collected current input data and further current input data with respect to one or more of the plurality of careers.

In an embodiment, for example prior to generation of the personalized data set 228, the method 200 may include predicting further current input data 222 based on historical data for training users in the same cluster as the current user, and determining whether to re-cluster 224 the current user based on the further current input data and a fit of the further current input data with respect to predicted further current input data based on historical data for training users in the same cluster as the current user.

In an embodiment, again for example prior to generation of the personalized data set 228, the method 200 may include predicting aptitude performance values for the current user with respect to one or more untested aptitudes 226, for example based at least in part on historical aptitude testing performance values 124 for training users in the same cluster as the current user, wherein the generated aggregate set of aptitude testing performance values comprises the predicted aptitude performance values.

In the embodiment of a method 200 as represented in FIG. 2, demographic data for the current user may be monitored over time 232, wherein the method 200 further includes dynamically determining, for example at relevant later stages in a career or pathway, whether to re-cluster the current user based on changes in the demographic data 224. In addition, or alternatively, the method 200 may include dynamically determining over time whether to regenerate the user-specific data set based on changes in demographic data associated with the user 234.

In an embodiment, the method 200 may include providing data associated with a current user (e.g., calculated, collected, derived, predicted, etc.) as model feedback representing another training user. In other words, at least some users may have personalized data sets generated based on a previously trained and validated model, while these personalized data sets and/or corresponding/underlying data are also provided as feedback to continue development of the model. In addition, or alternatively, the method 200 may include dynamically obtaining career-based feedback associated with one or more of the training users over time 232, and iteratively training the model to generate the clusters further accounting for the career-based feedback 230.

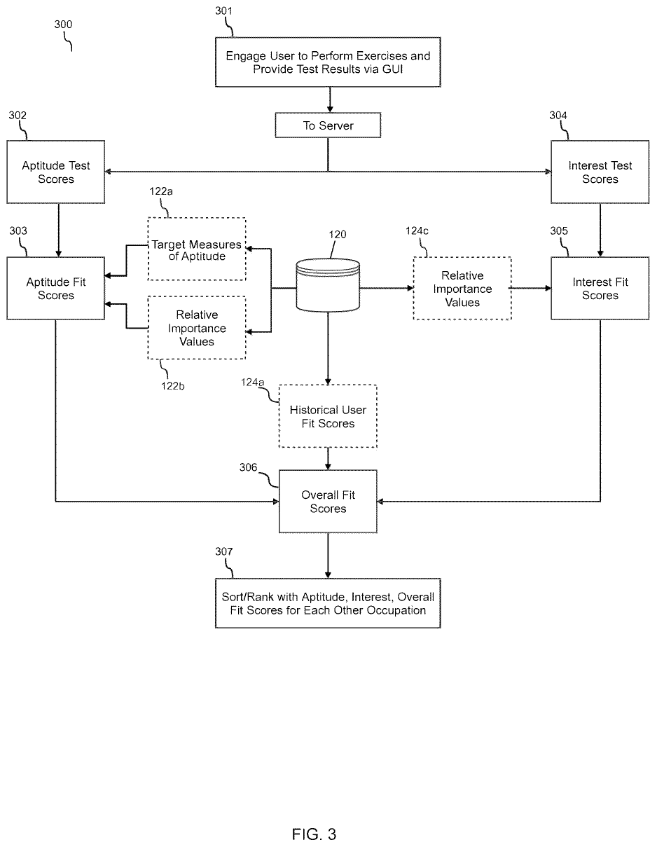

Referring now to FIG. 3, an exemplary career decision support method 300 according to the present disclosure, which may in some embodiments comprise part of the above-referenced method 200, may now be described.

A first step 301 may involve engaging a user to interact with a user interface of the host system, wherein software engines generate a set of exercises in the form of digital media and enable data entry by the user. The system may for example generate one or more test questions in a series for the user to complete, some or all of which may be timed. The time elapsed may be compared against a maximum time limit. Alternatively, a time limit may count down from a test maximum to zero.

The types, forms and content of the exercises may be proprietary in nature and may generally vary among administrators of a host system according to the present disclosure. Any number of exercises may be provided, some or all of which may comprise aptitude tests, interest tests, or combinations thereof. Preferably, the exercises are configured to require users to demonstrate respective aptitudes versus mere self-reporting. In one particular embodiment, the exercises may include the following exemplary aptitude tests, which are not intended as limiting on the scope of an invention according to the present disclosure.

A numerical computation test may measure the user's aptitude to apply basic math skills for simple computations. This aptitude is the mathematical foundation for such career choices as accounting, finance, computer programming, carpentry, engineering, and science.

A numerical reasoning test may measure a user's aptitude to find a numerical pattern in a series of numbers and apply the rule to complete the series. A high score on this test indicates an ability to use logical thinking in more complex mathematical problems. This is useful in finance, statistics, marketing, research, and many scientific fields.

A spatial visualization test may measure a user's aptitude to visualize from a two-to three-dimensional space. Typical careers with high spatial aptitude include architecture, medicine, engineering, construction, physical therapy, interior design, photography, and many of the arts.

An inductive reasoning test may measure a user's aptitude to see relationships in seemingly unrelated pieces of information and to rapidly draw conclusions. A high score in this reasoning style may indicate strength in seeing relationships between situations or the “big picture” quickly.

An analytical reasoning test may measure a user's aptitude to put logical structure to related ideas. This aptitude reflects the ability to systematically organize information, ideas or tasks. High analytical career examples include logistics, law, medicine, science, computer programming, architecture, and teaching.

An idea generation test may measure a user's aptitude to generate rapid and abundant flows of words and ideas in a limited period of time. This is a measure of creativity that taps into a person's ability to share ideas and thoughts on the spur of the moment. High idea generation is useful in journalism, teaching, sales, customer service, nursing, counseling, advertising, and public relations.

A hand/eye coordination test may measure a user's aptitude to quickly learn and execute skills that require the user to control the actions of his or her fingers, hand, or wrist in response to a visual display. A high score indicates an ability to learn new procedures quickly and perform manual tasks that involve a high degree of speed or precision.

An associative memory test may measure a user's aptitude to recall arbitrary sets of material. This ability is considered to be a measure of rote memory and is important for success in a range of occupational choices ranging from clerical and office work to technical, scientific, and organizational occupations.

A visual memory test may measure a user's aptitude to remember a series of numbers. This assessment indicates the level of ease or difficulty a user experiences in order to remember specific information that is heard or seen.

A word association test may measure a user's aptitude with respect to the personality characteristic of objective versus subjective orientation. Objective personalities are best satisfied in roles that rely on interpersonal competence or require strong interaction with other people. Subjective individuals are most comfortable making their own decisions and would likely find success as an accountant, tax lawyer, psychologist, engineer, radiologic technician, specialty repairperson or entrepreneur.

A vocabulary test may measure a user's aptitude with respect to knowledge of English words and written language. A user's score on this test indicates an ability to learn and integrate new information.

A clerical test may measure a user's aptitude to perform tasks that require perceptual speed and accuracy. Examples of careers requiring high clerical detail include teaching, counseling, construction and sales.

A conceptual mindset test may measure a user's aptitude with respect to the timeframes the user tends to consider when making plans for the future. This score indicates how a user will consider the impact of current actions on approaching plans or projects.

A figural attention test may measure a user's aptitude to recall an overall pattern or picture presented in two dimensions such as charts, diagrams, sketches and patterns. High scores indicate potential strength in the fields of science or art.

Various additional or alternative aptitude tests may of course be contemplated by those of skill in the art and within the scope of the present disclosure.

Software engines of the host system may then execute one or more assessment routines for each of the plurality of stored occupations, wherein respective aptitude and interest fit scores are generated for the user. The system first generates aptitude test scores from the results provided by the user with respect to each of a plurality of aptitude dimensions 302.

Generally speaking, the system may generate an aptitude fit score 303 for each of the plurality of stored occupations by mapping the respective aptitude test score against a respective target measure of aptitude 122a and a respective relative importance 122b for each of the respective aptitude dimensions. The target measure of aptitudes for each career may for example be utilized to measure an absolute value of the delta with respect to the performed measure.

In one embodiment, the various target measures of aptitude 122a may include or otherwise reference occupation-level O*NET ability composite scores calculated by software engines or otherwise entered into the system using proprietary algorithms. The scope of the present disclosure is not however limited to careers defined by O*NET, as one of skill in the art may readily appreciate the need and capability to define other careers for use within the system, and/or refer to other career sources.

The various occupation-specific values of relative importance 122b may further be calculated by software engines or otherwise entered into the system using proprietary algorithms that may in one embodiment reflect the importance of each aptitude dimension composite to a given occupation based on O*NET levels of importance ratings as are known in the art.

The system may further generate interest test scores 304 from the results provided by the user with respect to each of a plurality of interest dimensions. The system may then generate an interest fit score 305 for each of the plurality of stored occupations by mapping the respective interest test score against a respective relative importance 122c for each of the respective interest dimensions. In one exemplary embodiment, a “raw” interest fit score may be calculated for each user-occupation combination, as for example the Pearson correlation (r) between a vector of scaled interest scores from the user's test results and a vector of O*NET level of importance ratings for the interest dimensions for a given O*NET occupation. A scaled interest fit score may then be calculated for each user-occupation combination.

In various embodiments, a career decision support system according to the present disclosure may generate one or more additional or alternative fit scores for other relevant areas that may be determined worthy of consideration with respect to various user-occupation combinations. For example, one additional or alternative area may include work values such as may be associated with satisfaction in the particular career, such as advancement, prestige, etc. Another example of an additional or alternative area may include personality dimensions such as extroversion, agreeableness, openness, willingness to invest in post-secondary education or desired locations, etc., that may be associated with success and performance in a particular career. For each of these areas, the accumulation of test data from a user and generation of respective fit scores may incorporate a process substantially similar to either or both of those used for the aptitude and interests fit scores described above.

It may further be noted that the combination of fit scores that are relevant to a particular occupation and/or career may vary, although this would typically be addressed via weighting of the respective fit scores rather than lack of consideration entirely by the program algorithms.

An overall fit score 306 may then be generated for the occupation based on the respective aptitude fit scores 303 and interest fit scores 305, and/or any other fit scores that are generated with respect to other areas relevant for consideration, such as for example historical user fit scores 306 retrieved from the database 120 or an associated data storage network. In an embodiment, a scaled overall fit score may be calculated for each user-occupation combination.

The system may then rank the overall fit scores for each of the plurality of occupations, or otherwise enable sorting by the user with respect to a number of available options, including for example the respective aptitude fit scores, interest fit scores, overall fit scores, etc. 307.

In an embodiment, determining a program fit score and associated fit between one or more user candidates and a program according to the present disclosure may include determining one or more aptitude, interest, and overall fit scores for one or more engaged users (program “candidates”). For example, a minimum of three values may be calculated for each unique user-career pair (aptitude, interest, and overall fit scores), wherein at least one thousand five hundred values may for example be calculated for five hundred careers. The system may identify a program, for example based upon user input and/or selection, such as for example a school administrator selecting an associated academic program for determining the best candidates therefor, and determine careers associated with the program. In another embodiment, the system may identify a program based upon one more career-program matching parameters, such as an algorithm comparing a candidates' one or more career fit scores to scoring thresholds associated with each associated career/occupation. For example, the system may determine a given candidates' career fit scores associated with law and business exceed required thresholds for a university's J.D/LLM Program and may select such program or associated programs without requiring user/administrator direction. In another embodiment, the system may identify a program for which a candidate's overall fit scores for a program's associated careers are non-null (i.e., an overall fit score exists, and its value can be determined).

In an embodiment, a program comprising 127 associated careers may further be uniquely associated with variable career weights for each of the 127 careers in accordance with the degree of importance or representation of that career. For example, a law program associated with at least the careers “Lawyer,” “Paralegal,” and “Accountant” may, for each career, have an associated weight in accordance with the representation of said career in the general career path the given program: e.g., Lawyer=0.68, Paralegal=0.12, Accountant=0.04, and the remaining 0.12 is made up of the other associated careers with non-zero values. The associated program-career weights may generally reflect the relative percentage of representation each career has as a probable career for a graduate of the program. In another embodiment, the associated program-career weights may be non-representative of real-world career percentages in accordance with other program-based values. For example, greater weight may be afforded to careers with higher earning potential, reported job satisfaction, employee demand, etc.

Other embodiments may use different weighting factors to achieve a more open-ended career impact assessment. For example, as opposed to the above careers being weighted to add up to 100%, a variable weight percentage may be added to each career based upon a relationship factor, such as “lawyer” and “paralegal” may each be weighed at 100% relation to a law career, whereas accountant may be weighed at 25% relation to a law career. Accordingly, new careers may be added in association to a career without adjusting the relationship weights of other previously associated careers. Career weightings may be determined primarily based upon the correlation to the program and then secondarily based upon listed program-career factors, e.g., job and wage growth.

Each career fit score may be weighed against the program-career variable weights and then each product summed and further divided by the sum of the total weights of all careers associated with the program to achieve a general program fit score, wherein in an embodiment the general program fit score is a weighted average of the product of each career fit score against its associated program-associated weight.

In an embodiment of method 200 or method 300, a user may select one or more program parameters or candidate parameters to apply to one or more candidates' general program fit scores. For example, an administrator may choose to filter or sort, for a particular program, candidates based on graduation year, school, age range, geography, program fit selectivity (e.g., top 10%, top 50, etc.), or other user-defined parameter not defined exclusively within the program data and associated career weights. For each user-selected parameter, the system may determine a variable weight value. The variable weight value may be multiplicative, whereby the product of the general program fit scores and one or more variable weight values is determined. In another embodiment, the variable weight value may be additive, whereby the one or more variable weight values are summed with the general program fit score.

The system may then apply the one or more variable weight values to the general program fit score in accordance with one or more program fit score weighing algorithms to determine a weighted program fit score. The weighted program fit score may be generally associated with the associated candidate's expected success within a given program in accordance with user parameters selected. In embodiments where no user parameters are selected or available, the weighted program fit score may be, and/or be equal to, the general program fit score.

It will be understood by those of skill in the art that navigating between user interface views within the system is accomplished by selecting a tab or object in a current user interface view corresponding to another user interface view, and in response to selecting the tab or object, the user interface updates with said another user interface view corresponding to the selected tab or object.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

Also disclosed herein are vocational guidance methods that can be implemented by assessing a battery of tests to an examinee, each test in the battery of tests or exercises pertaining to an aptitude measurement category previously determined to be of interest, for example, numerical reasoning, spatial visualization, deductive reasoning, inductive reasoning, analytical reasoning, idea generation, hand/eye coordination, visual memory, word association, vocabulary, clerical aptitude, conceptual mindset, figural attention, or any other aptitude measurement category disclosed herein.

According to some aspects of the present disclosure, each test in the battery of tests (that is, a battery of tests that pertains to the full range of measurement/aptitude categories) can be administered to the examinee. In some cases, the order of the administered tests can be fixed. In other examples, the order of the administered tests can be flexible based on one or more results of the initial testing.

The results of the full battery of tests can thereafter be used to provide one or more aptitude fit scores for the examinee, for example, an aptitude fit score corresponding to each of the measurement/aptitude categories. These aptitude fit scores can be used to predict one or more suggested educational, skill development, and/or career pathways for the examinee, as previously disclosed herein. These aptitude fit scores can also be combined with one or more examinee preference inputs, as previously discussed, to determine the one or more suggested educational, skill development, and/or career pathways for the examinee.

The inventors have discovered, however, that as time required to complete an aptitude-based vocational guidance test increases, the overall quality of test-taker answers tends to decrease. In addition, the amount of class time, or time away from work, required to complete the test limits the quantity of users that can avail themselves of this career guidance technology. Accordingly, it may be impractical to administer every test in the battery of tests (or, in other words, to directly measure each aptitude While the time to conduct an aptitude-based vocational guidance can be reduced simply by reducing the number of tests administered (for example, by removing a number of aptitude measurement categories from the set to be tested), eliminating tests arbitrarily from the battery of tests, and particularly from a fixed-order examination process, can significantly reduce the accuracy of the suggested educational, skill development, and/or career pathways for the examinee. For example, the inventors have discovered that, in the case of a battery of tests covering a battery of 14 aptitude categories, tests related to 5 of the 14 aptitude measures could be made optional to reduce testing time without an unacceptable loss of result accuracy but removing or making optional an additional 2-3 aptitude measures in any combination caused unacceptable loss of recommendation accuracy. In other instances, such as for example in the context of a guidance system directed to middle school students, a more limited scope of aptitude inputs may be offset by reducing the specificity of the resulting career guidance to a career cluster level, as further described below.

However, by comparing the results from a limited subset of the battery of tests taken by an examinee to full test result tests previously gathered from examinees who have taken the full battery of tests, it is possible to both identify a subset of additional tests which will establish aptitude values in the most relevant aptitude measure categories for that examinee, and to extrapolate predictive or likely results on untested aptitude measures for the examinee. The various aspects of the disclosure presented herein concern vocational guidance examination methods. Generally, the vocational guidance examination methods disclosed herein comprise at least a screening test and an adaptive test administered after the screening test. Various aspects of such vocational guidance methods with shorter administration times are disclosed herein.

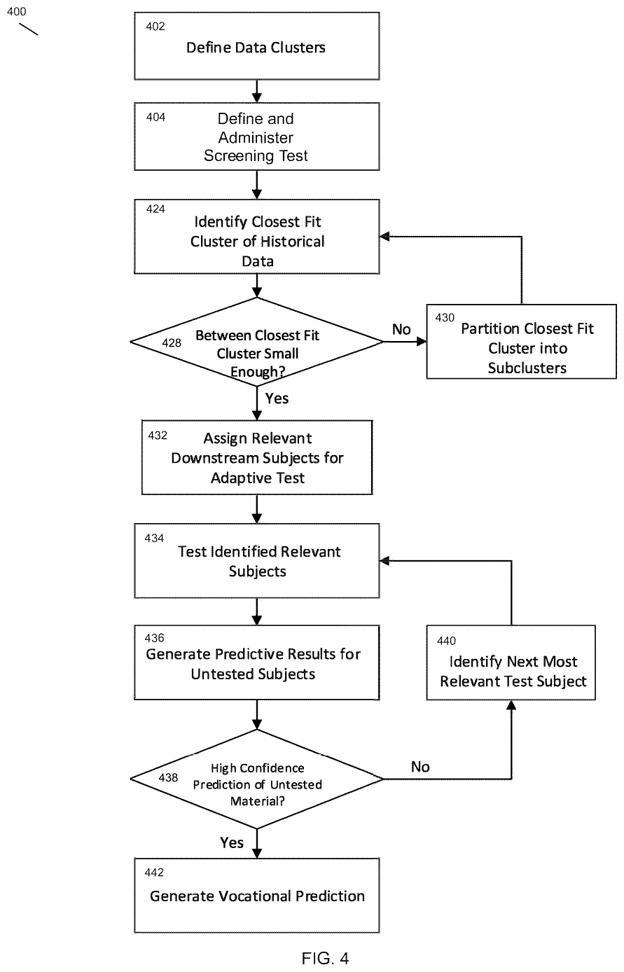

An embodiment of a vocational guidance method 400 for implementing an aptitude-based vocational guidance test according to one example is outlined in FIG. 4. The method 400 may in some embodiments comprise part of the above-referenced embodiment of method 200. As shown in FIG. 4, the vocational guidance method 400 can begin by clustering available historical test data 402. With clusters defined, the method can also include defining and administering a screening (e.g., preliminary) test, based on the historical test data, to an examinee 404. The vocational guidance method 400 can also include using the result of the preliminary or screening test to assign the examinee to a pre-defined data cluster of historical aptitude-based vocational guidance test results for a subject population of historical examinees.

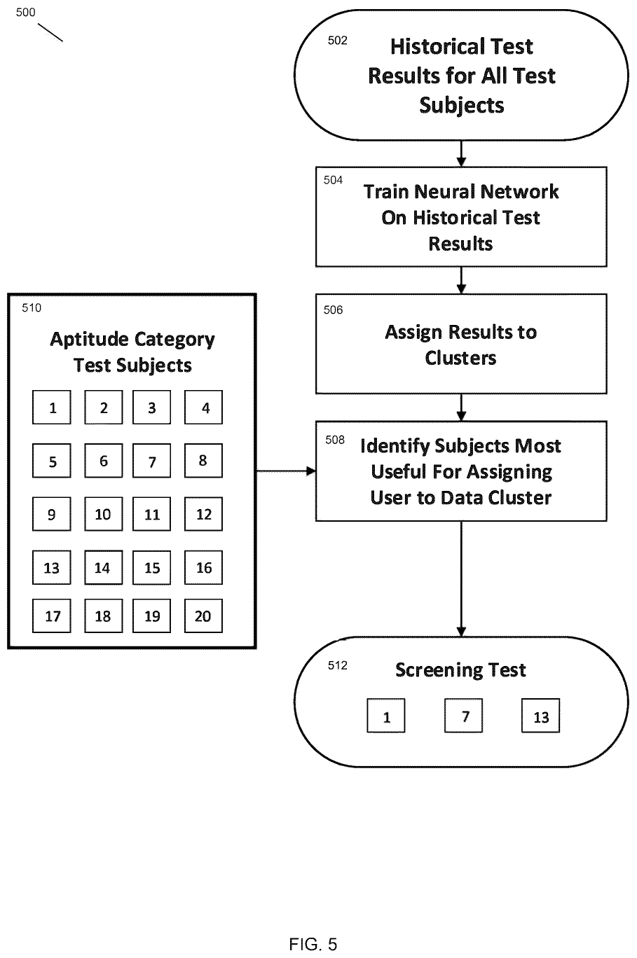

A user is associated with one of the defined data clusters by using a screening test generated based on a body of preexisting data and aptitude and/or proficiency categories. A procedure 500 for defining one or more pre-defined data clusters of historical aptitude-based vocational guidance test results, and for developing a screening test to sort an examinee into one of the data clusters, according to one aspect of the present disclosure is outlined in FIG. 5. As shown in FIG. 5, the procedure 500 begins with a body of historical test data 502 including data on a plurality of aptitude test subjects for the subject population of historical examinees. A neural network can be trained 504 using all or some of the historical test data 502 for each aptitude category test subject 510. The neutral network can then be used to assign the subject population of historical examinees to one or more “clusters” of similarly performing historical examinees 506 (that is, historical examinees with similar historical test data on the aptitude test subjects 510).

A neural network as referenced herein may include a feed-forward or recurrent structure including various input nodes feeding an input port which is connected to an output port and consequently one or more output nodes via one or more hidden layers of neurons. In an embodiment, the hidden layers may comprise one or more layers of artificial neurons each of which include one or more computational units or functions. An individual layer may for example receive its weighted inputs from respectively connected neurons of the previous layer, which may be aggregated along with a scaling bias unit for improved convergence properties.

Models according to the present disclosure may for example be trained using “test” datasets from historical user inputs, and the trained and validated models may further be utilized for prediction based on “current” datasets. The current datasets may further be utilized as feedback and accordingly a test dataset for further training and/or validation of the existing models. Training data for the neural network may for example be obtained from one or more assessments as previously described herein, optionally further in view of inputs from other data sources including current or predicted career and/or pathway conditions or demographics, user demographics, user-specified career interests, user-specified career history and associated feedback, and the like. For example, user clusters otherwise based solely on aptitude assessments may be further differentiated in terms of career correlation based on demographics such as age, location, family status, career and/or educational history, and the like. For example, a high school student, a 35-year old military veteran, and an individual facing early retirement in their present career may present markedly different predictive career correlations in many contexts, notwithstanding virtually identical aptitude and even interest assessments, even where for example these descriptions relate to the same individual at different stages of their respective life. Such demographic dynamism in career correlation, and for example in respective pathways, may be accounted for using appropriately configured feedback channels and iteratively trained models as disclosed herein for potential reclustering or even subclustering of an otherwise common aptitude-based cluster to account for demographic or other equivalent distinctions. The term “reclustering” as used herein may for example refer to reassigning the cluster to which a user should belong, whether that is a subcluster of the first cluster or an entirely different cluster family.

Various embodiments of machine learning models as known in the art include variable governing parameters which are optimized during training to better simulate (or approximate in a particular simulation) observed real-life results corresponding to an input dataset, which as previously noted may include sets of aptitude testing performance values. Such parameters may initially be set (e.g., user-specified) before training. Tuning of the hyperparameters, or in other words optimizing the values therefor, follows during training to obtain a set of values for the parameters corresponding to an accurate input-output mapping of the neural network for the training dataset. In various embodiments, tuning of parameters may be performed automatically during or between training iterations, manually based on user selection via a system interface, or combinations thereof. In some embodiments the parameters are not initially user-specified but instead predetermined formulaically or otherwise according to a “best guess” distribution of possible simulation parameters corresponding to a specified career output array, and in some embodiments may initially be unknown and merely derived during training. The parameters may for example determine aspects of the neural network structure and/or training parameters, such as the number of hidden neuron layers, number and/or definition of training steps, learning rates, batch size, and the like.

During training of the neural network, parameters for the neural network may accordingly be varied in order for the neural network career outputs to sufficiently align with desired measures for the known dataset, and preferably optimized to minimize cross-validation losses. User input may be utilized for parameter optimization, for example to satisfy a desired learning rate and corresponding convergence characteristics to reduce the amount of input data points required in an exemplary aptitude assessment procedure, even possibly at the expense of overall accuracy.

A model may be considered to be sufficiently trained when career predictions best correlate to what is actually observed in response to respective input datasets. However, such observations may be inherently difficult to characterize in the short term. For example, a particular user may ultimately select a career that was predicted by the model, which provides validation in the short term, but subsequently determine that the career choice was suboptimal, wherein downstream feedback may be provided and relevant to further training and validation of the model and the underlying parameters, correlations, weightings, etc. Accordingly, training and validation may be considered as an iterative process, and indeed in various embodiments accounting for feedback that is obtained long after the initial predictions. One exemplary feedback channel may correspond to career satisfaction, events, trajectory, time spent at various positions, and the like. Another exemplary feedback channel may relate to changing demographics, for example as corresponding to above-referenced elements of the first feedback channel but not limited thereto. Other exemplary feedback channels may relate to career pathways (e.g., educational systems, programs, or other tools associated with preparation for a given career) and downstream evidence relating to observed errors in expected correlations between such pathways (e.g., a type of pathway as a whole, or individual examples thereof) and careers or career combinations. Educational pathway performance and pathway completion may be examples of objective measures in this context.

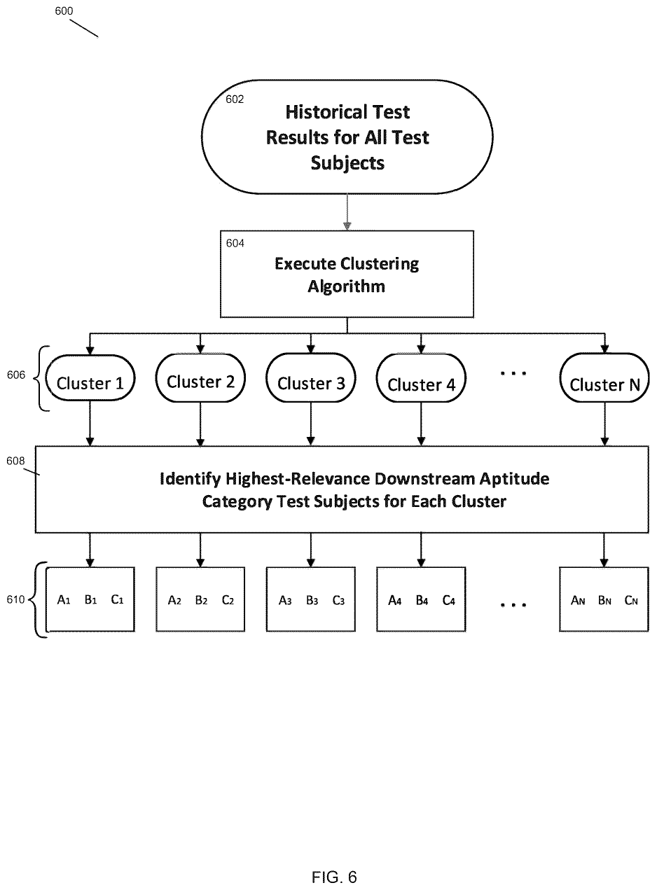

FIG. 6 illustrates, in association with or otherwise distinguishable in part from any or all of methods 200, 300, 400, 500, a process 600 for sorting historical test data 602 for the plurality of historical examinees into a plurality of clusters of related subgroups of historical examinees with similar attributes or responses, or into subgroups of similarly performing historical examinees, according to one aspect of the present disclosure. As shown in FIG. 6, after the neural network has been trained on the historical test data 602, it can follow a clustering algorithm 604 for sorting the historical test data into subgroups of clusters 606. A typical clustering algorithm may begin with a training data set with well-understood characteristics, which may be used to define one or more parameters which can thereafter be used to sort the available historical test data into a plurality of n data clusters 606. Parameters for sorting data can include a minimum or maximum number of data clusters, a minimum degree of closeness (or maximum degree of deviation) for data within a cluster, or within all clusters, a minimum or maximum size of a data cluster, or the like.

For example, the training data set can be used to define one or more features or characteristics to be compared between data points or data sets, and to determine by how much the data differs across the one or more features. The clustering algorithm can then group data in such a way as to meet one or more predefined criteria. For example, a clustering algorithm might be instructed to split data into groups such that one or more of the features or characteristics have a maximum difference (or minimum similarity) in each group. Alternatively, or in addition to this requirement, the clustering algorithm may be instructed to achieve the arrangement of data clusters such that the total (or global) difference in one or more of the predetermined features or characteristics amongst all clusters is minimized. In some embodiments, further micro-segmentation within one or more data clusters may be desired for further meaningful discrimination, wherein sub-clustering operations may be performed.

According to some aspects of the present disclosure, the sorting algorithm may also identify interrelations and correlations between one or more data clusters, which may allow for the clustering algorithm to, when new data is added to the historical test data, update more than the single cluster to which the new data is added.

Additional requirements may be imposed on the clustering algorithm, and it will be appreciated by one skilled in the art that the sorting criteria can be adjusted based on the nature of the data set being sorted and the specific aims of the sorting. It will also be appreciated by one skilled in the art that the number, size, and interrelation of the clusters formed may vary based on the input data set as well as the specific sorting criteria used in any given sorting process.

It will be appreciated that various classes of clustering algorithm may be used, depending on the precise needs of the data set and the priorities defined for the clustering algorithm. For example, the sorting algorithm may be a bottom-up clustering algorithm, which considers an unsorted data set identifies and associates nearest-neighbor data points and/or data sets and continues to aggregate nearest-neighbor data until the sorting criteria are met. In another example, the sorting algorithm may be a divisive clustering algorithm, which begins by placing all data in a single cluster, and then subdivides the initial cluster to smaller, more closely related clusters. In another example, the clustering algorithm may begin by arbitrarily distributing the data into a number, n, of data clusters, moving individual points between clusters, and retaining only those moves which reduce the overall cluster variance of the system.

As the clustering algorithm 604 sorts some or all of the historical test data 602 into the plurality of data clusters 606, as illustrated in FIG. 6, it may also determine or otherwise identify 608 which aptitude test subjects have results that most closely determine or most accurately predict how the historical test data is sorted into the plurality of data clusters. The identified aptitude test subjects 510, as represented in FIG. 5, which most closely determine or most accurately predict how the historical test data is sorted into the plurality of data clusters 606 can thereafter be used to sort new data (for example, test results from new examinees) into the plurality of data clusters 606, which may form the basis for a screening test to be administered, for example as previously discussed with reference to FIG. 4 at block 404. In the example illustrated in FIG. 5, in a test having a set of aptitude test subjects 510, numbered 1-20, the clustering algorithm may determine that aptitude test subjects 510 numbered 1, 7, and 13 have the greatest predictive value for sorting new data into one of n data clusters 606. The clustering algorithm then identifies that a screening test 512 comprising aptitude test subjects 1, 7, and 13 should be administered to new examinees of an embodiment of the vocational guidance method 400, 500, 600.

Preferably, a limited number of aptitude test subjects 510 will be identified and selected 508 to form the screening test 512. For example, according to some aspects of the present disclosure, the screening test 512 can include three aptitude test subjects 510. According to other aspects of the present disclosure, the screening test 512 can include a different number of aptitude test subjects 510, depending on how many aptitude test subjects 510 are required to form n data clusters of the desired size and statistical closeness. It may be appreciated that, as the number of aptitude test subjects 510 in the screening test 512 increases, the accuracy with which an examinee is assigned to a data cluster may increase but result in a longer screening test 512. Therefore, it is particularly advantageous for the screening test 512 to include as few aptitude test subjects 510 as is required for a sufficiently high accuracy assignment of the examinee to a data cluster.

Referring again to FIGS. 5 and/or 6, once the historical test data 502, 602 has been sorted into the data clusters 606, and the aptitude test subjects 510 making up the screening test 512 have been identified, the screening test 512 may be administered to the examinee (e.g., process block 404 of FIG. 4). The results on the screening test 512 may then be used to assign the examinee to the data cluster 606 that best correlates to (that is, has the lowest variance from) the results for that examinee on the screening test 512, which contains historical test data 502, 602 for historical examinees with results for the aptitude test subjects 510 on the screening test 512 most closely matching those of the examinee.

An embodiment of a vocational guidance method 400, 500, 600 may also include assessing how well the screening test 512 results of the present examinee correlate to the other results in the best-fit data cluster 606 and comparing the measured variance against a predefined threshold for allowable variance (e.g., 428 in FIG. 4). If the data cluster to which the examinee is assigned has too great a variation in data (that is, the variance exceeds the variance threshold), or too great an average difference between the data of the present examinee and that of historical examinees assigned to the data cluster, the closest-fit data cluster can be further divided into one or more subclusters 430, which groups the examinee's screening test results with a smaller, but more closely-related subset of the historical test data. This process can be repeated until the variance between the examinee's screening test results and the historical test data in the remaining subcluster is below the variance threshold.

Referring again to FIG. 6, after the plurality of data clusters 606 have been identified, statistical analysis of the historical test data 602 in each data cluster can be used to identify one or more additional aptitude test subjects which are the most statistically significant for downstream (that is, later) predictions 608.

For example, according to one aspect of the present disclosure, it may be possible to determine which aptitude test subjects 510 are related to the greatest variance of results within any single data cluster 606. This may be done, for example, by determining, from the historical test data 502, 602 in a single data cluster, how varying the results in a first aptitude test measure correlates to a change in the other aptitude test subjects 510. If a change in test results of the first aptitude test measure correlates to a comparatively high variation in the results of the other aptitude test subjects 510 for data in the data cluster 606, then that aptitude test measure has a comparatively high predictive value for the data cluster 606 in question. Conversely, if a change in the test results of the first aptitude test measure correlates to a comparatively minor change in the results of the other aptitude test subjects 510 for data in the data cluster 606, then that aptitude test measure has a comparatively low predictive value for the data cluster 606 in question.

By assessing the predictive value of each aptitude test subject 510 for the historical test data 502, 602 in a given data cluster 606, the most and least relevant aptitude test subjects 510 for predictive purposes can be identified for each data cluster 606. These aptitude test subjects 510 can then be included in an adaptive aptitude exam 610 for downstream administration (that is, to be administered after an examinee has been assigned to or associated with a data cluster) for each data cluster 606, which tests only the most relevant aptitude test subjects 510 for each data cluster 606.

For example, as illustrated in FIGS. 5-6, after the historical test data 602 has been divided into n data clusters 606 (that is, the data clusters 1 through N shown), statistical analysis can provide one or more aptitude test subjects 510, A, B, C, etc. for each data cluster 1 through N which are most statistically relevant for a test taker who is assigned to any given data cluster 606. It will be appreciated that, in some aspects of the present disclosure, the most relevant aptitude test subjects 510 can be determined for each data cluster 606 before an examinee takes the screening test 512. The most relevant aptitude test subjects 510 may or may not be updated or reassessed depending on the results of the screening test 512. For example, in some instances it may be determined that the results of the screening test 512 are unlikely to change which aptitude test subjects 510 are most relevant for a data cluster 606, and the adaptive aptitude exam 610 for that data cluster 606 can be static (that is, not adjusted based on the results of the screening test 512). In other instances, it may be determined that the most statistically relevant aptitude test subjects 510 for a data cluster 606 will vary for each examinee depending on the results of the screening test 512, and in such cases the aptitude test subjects 510 included in the adaptive aptitude exam 610 can either be determined after results for the screening test 512 have been obtained, or can be determined beforehand and adjusted according to the results of the screening test 512 for each examinee.

It will further be appreciated that, while FIG. 6 shows three additional aptitude test subjects 510 identified for each data cluster 518 and included in a downstream, tailored aptitude exam, the number of additional aptitude test subjects 510 may vary based on a number of factors, including, for example, the size of the data cluster 518, the degree of variance of data within the data cluster 518, the number of aptitude test subjects 510 that have a high degree of statistical relevance for the data cluster 518, and the degree of statistical relevance for any aptitude test subjects 510 for the data cluster 518. Thus, in some cases, it may be determined that accurate predictions can be made for an examinee with data on fewer than three additional aptitude test subjects 510, and the adaptive aptitude exam 526 for that data cluster 518 may contain two or one aptitude test subjects 510. In other cases, it may be determined that data on more than three aptitude test subjects 510 are required for a sufficiently accurate prediction for an examinee, and the adaptive aptitude exam 526 can include four, five, or more than five aptitude test subjects 510.

According to one aspect of the present disclosure, as further represented in FIG. 4, once the examinee is assigned 424 to a data cluster and an adaptive aptitude exam is defined 432 for the combination of data cluster and the examinee's screening test results when applicable, the adaptive aptitude exam is administered 434 to the examinee to generate an empirical result for the tested aptitude test subjects 510.

The empirical result for the aptitude test subjects 510 from the adaptive aptitude exam 610 can then be used, in conjunction with the results of the screening test 512 and available historical test data 502, 602 for examinees that have completed the full battery of tests associated with all aptitude test subjects 510 to generate predictive results 436 for any aptitude test subjects 510 that have not been tested. According to one aspect of the present disclosure, the predictive results can be generated by a neural network.

It may be appreciated that the predictive results can be generated 436 in various ways. For example, the predictive results can be generated by collecting all historical test data 502, 602 within the data cluster associated with the examinee. The historical test data 502, 602 which match or are substantially identical to the results of the current examinee can be used to provide an average value or estimated range for all remaining aptitude test subjects 510. In some cases where a range or average is provided, a confidence value, a confidence interval and/or predicted error margins may also be provided.

According to one aspect of the present disclosure, when the predictive results are generated 436, the neural network or other source of the predictive results can also generate a confidence value, which represents a prediction of the accuracy of the predictively generated values for the untested aptitude test subjects. In some examples, the confidence value can be compared to a designated confidence threshold; that is, a determination can be made 438 regarding whether the predicted accuracy of the generated values for the untested aptitude test subject results is acceptable, or whether the predicted accuracy of the generated values for the untested aptitude test subject results is too low.

When the confidence value is below the threshold value (that is, when confidence in the predicted results is too low), one or more additional aptitude test subjects 510 can be tested in addition to those tested in the adaptive aptitude exam 610. According to one aspect of the present disclosure, the additional aptitude test subjects 510 will be tested in order of estimated relevance 440. For example, if the adaptive aptitude exam 610 included tests on the three most relevant aptitude test subjects 510, but the confidence value on the predictively generated results for the remaining aptitude test subjects 510 is too low after the adaptive aptitude exam 610 is administered, the fourth most relevant aptitude test measure 510 can be directly tested 434, new predictive results generated 436, and a new confidence value generated 438. This process may be repeated each time testing the next most relevant aptitude test subjects 510 (for example, the fifth, sixth, and so on most relevant aptitude test measure) until the confidence value meets or exceeds the designated threshold.

Without being bound to any particular theory, it is presently believed that this process is particularly well-suited to providing predictive results for edge-case test takers, with less common results on the screening test 512, and who accordingly are assigned to a smaller or less populated data cluster 606 or subcluster thereof.

Advantageously, by predictively generating results in this way, various embodiments of a vocational guidance method as disclosed herein allow for a completed set of data for all aptitude test subjects 510 to be generated for the examinee without administering a fully battery of aptitude tests. Only as many aptitude test subjects 510 are tested as are required to create a predictive result for all aptitude test subjects 510 with adequate confidence, thus conducting the minimum number of tests, while preserving predictive integrity of the vocational guidance method. This can greatly reduce the total time it takes to administer the vocational guidance method, when compared to a vocational guidance method that requires administering a full battery of fixed-order tests.

With the generation of the predictive results for all untested aptitude test subjects 510, the test taker will have a full set of scores for each aptitude test measure. Using this complete set of aptitude test measure scores, a vocational prediction (e.g., fit score) can be generated 442 for one or more prospective career and/or educational objectives or paths and used to provide vocational recommendations to the examinee.

According to one aspect of the present disclosure, a set of career aptitude fit scores can be combined with one or more other factors, such as examinee-indicated interest in the one or more career and/or educational paths, measures of additional skills or proficiencies, academic record, academic credentials, professional credentials, or other certifications to further develop the vocational recommendations. Additionally, alternative measures of abilities or examinee performance metrics, such as examinee strength, visual acuity, audio recognition, and the like may be combined with any of the above to further assist with the definition of vocational recommendations.

According to one aspect of the present disclosure, a large language model (LLM) data source may be combined with the predictive results for the aptitude test subjects to improve a vocational recommendation.

According to one aspect of the present disclosure, examinee feedback on the vocational recommendation or on multiple vocational recommendations can be solicited, and used to further rank examinee preference and/or the suitability of the vocational recommendations presented to the examinee.

According to one aspect of the present disclosure, the determination of the vocational recommendations can take various local factors into consideration, such as locally available educational programs, local job demand, local market and economic history, and local employers.

According to one aspect of the present disclosure, any of the predictive statistical models, neural networks, or clustering artificial intelligence processes can be retrained after any of several steps of the vocational guidance methods disclosed herein.

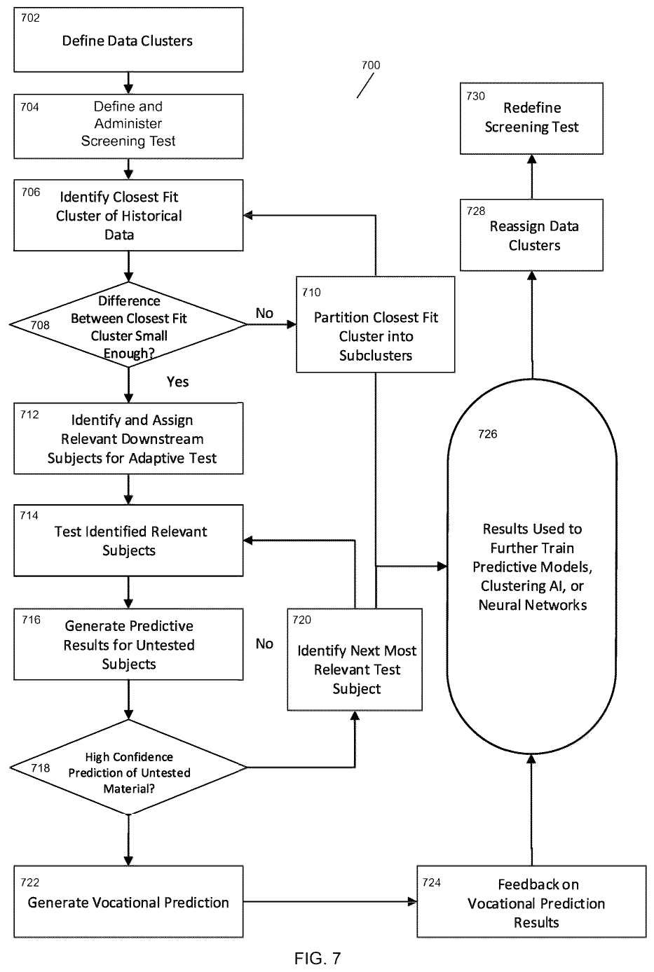

FIG. 7 illustrates an example vocational guidance method 700 that includes retraining of the statistical models, neural networks, and clustering artificial intelligence processes. The vocational guidance method 700 may be substantially similar to one or more of the previously described embodiments of a vocational guidance method, or otherwise executed as part of or in combination with one or more of the previously described embodiments of a vocational guidance method, except for the specific variations and differences described herein. For example, the details of steps 702 to 722 as illustrated in FIG. 7 are substantially similar to those of steps 402 to 442 in FIG. 4 except for further description provided below.

As shown in FIG. 7, the one or more predictive models, neural networks and/or clustering artificial intelligences can be trained on new data at any one of several points in the method. According to one aspect of the present disclosure, for example, if there is no data cluster with a sufficiently small variance between the examinee results from the screening test and the data in the data cluster, it may be an indication that the clustering artificial intelligence which produced the data clusters requires additional training or feedback to improve the quality and relevance of the data clusters for future test takers, and one or more parameters and/or clustering criteria, such as the size of the clusters, the number of the clusters, and/or the acceptable variance of the data within the data cluster can be adjusted accordingly to improve the quality of the data clusters in subsequent iterations of the vocational guidance method 700. In such examples, data from the sub-clustering process of process block 710 can be used to further train the clustering AI 726. In some cases, the retrained clustering AI can further reassign data clusters and make required adjustments in light of the further training 728. In some examples, the retrained clustering AI can also assess whether a different set of aptitude test subjects 510 is a better predictor of the newly assigned data clusters, and the screening test 512 can be adjusted accordingly 730.

According to another aspect of the present disclosure, for example, the one or more predictive models, neural networks and/or clustering artificial intelligences can be updated following process blocks 718 and 720, in the event that the identified aptitude test subjects 510 that make up the adaptive aptitude exam 610 do not produce a set of predictively generated results for untested aptitude test subjects 510 with a sufficient degree of confidence, prompting one or more additional aptitude test subjects to be tested 714. This may be an indication, in some cases, that the neural network process which selected the aptitude test subjects 510 which made up the adaptive aptitude exam 610 requires adjustment and/or reweighting of one or more of the criteria for the selection of aptitude test subjects 510 for the adaptive aptitude exam 610. Accordingly, one or more such adjustments can be made to improve the quality of the adaptive aptitude exam 610 generated in subsequent iterations of a vocational guidance method as disclosed herein.

Additionally, the predictive results and/or one or more vocational predictions 722 can be compared to feedback from the examinee, an education program, an employment program, an employer, a vocational guidance counselor or a combination thereof on the suitability of any recommendations made 724 by vocational guidance methods disclosed herein. For example, an examinee of the vocational guidance method may be a student that receives one or more academic course suggestions based on high tested or predicted scores in one or more aptitude test subjects 510 after completing the screening test 512 and the adaptive aptitude exam 610, such as a recommendation to take one or more courses in mathematics, science, computer programming, writing, foreign language, or so forth. At the completion of the one or more recommended courses, the performance of the student may be rated, for example, on a grading scale, to determine whether the recommendation that the student would succeed in these courses was accurate, and the one or more predictive models, neural networks and/or clustering artificial intelligences can be updated accordingly. Alternatively, or additionally, the student can provide feedback on whether the vocational guidance and/or suggestion was useful.

Furthermore, because in various embodiments a vocational guidance method as disclosed herein provides, between the screening test 512, the adaptive aptitude exam 610, and the predicted aptitude test measure results, a comprehensive set of results for each aptitude test subject 510 for the examinee, this data may be added to the historical test data 502, 602 of the vocational guidance method, to further improve the quality of subsequent administrations of the vocational guidance method.

Advantageously, because examinee results in many aptitude test subjects 510 are predictively generated based on the empirical results of a comparatively smaller body of tested aptitude test subjects 510, the time which it takes the examinee to complete both components of a vocational guidance method as disclosed herein can be greatly reduced. According to some aspects of the present disclosure, the total time to examinee completion of both the screening test 512 and the adaptive aptitude exam 610 can be reduced to 120 minutes or less. In specific examples, the screening test 512 and the adaptive aptitude exam 610 can be completed in 90 minutes or less, such as within 90 minutes, within 80 minutes, within 70 minutes, within 60 minutes, within 50 minutes, or within 40 minutes.

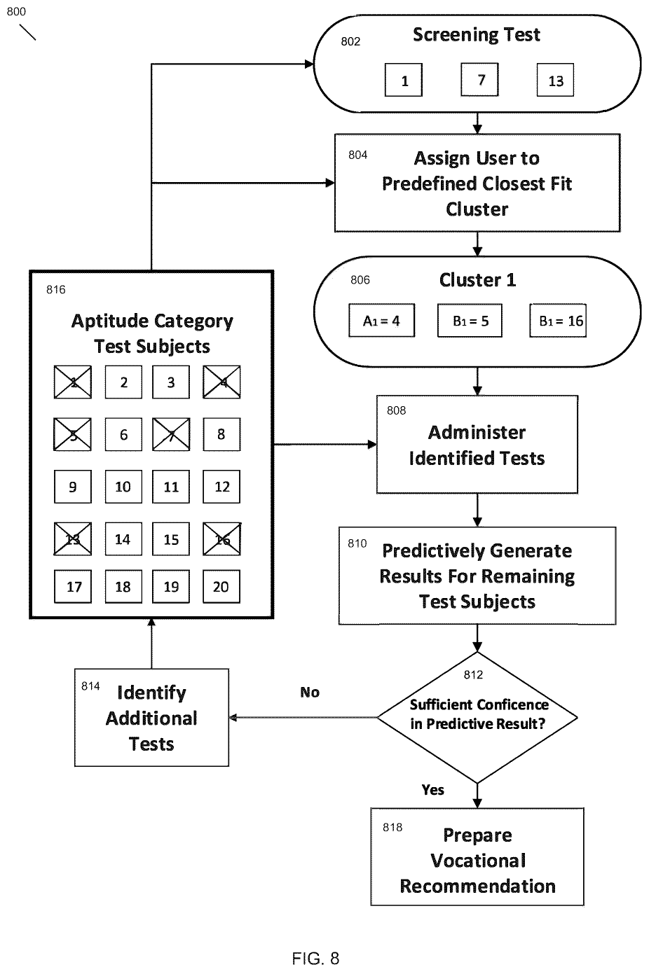

To illustrate one example of how the vocational guidance methods disclosed herein might generate a vocational recommendation for an examinee, an example testing method 800 is outlined in FIG. 8. In the aspect of the present disclosure shown in FIG. 8, the example testing method 800 includes a battery of 20 aptitude category test subjects 816, numbered 1-20 for the purposes of this example. After the data clusters have been defined (e.g., relating to process block 402 of FIG. 4), a screening test 802 comprising one or more aptitude category test subjects 816 is defined. In the illustrated example, the screening test 802 comprises three aptitude category test subjects: subjects 1, 7, and 13, but will be appreciated that the screening test 802 can comprise different aptitude category test subjects 816 or a different number of aptitude category test subjects 816.

The defined screening test 802 can then be administered to the examinee 804. That is, the examinee will then answer one or more questions on each of the identified aptitude category test subjects 816 to generate a result for each of the tested aptitude category test subjects. The result for the tested aptitude category test subjects is then used to assign the examinee to a historical data cluster 806, for example, cluster 1 as shown in FIG. 8. If the variance between the examinee's results on the screening test 802 (that is, in tested aptitude category test subjects 1, 7, and 113) and the historical data in the historical data cluster 806 is below the maximum allowable variance, then no adjustment of the cluster is needed, as shown in FIG. 8. However, it is to be understood that if the variance between the examinee's results and the historical data in the historical data cluster 806 exceeds the maximum allowable variance, then the historical data cluster 806 may be further divided to produce a subcluster that more closely matches the examinee's results on the screening test 802, as discussed previously herein.

After the examinee has been assigned to a data cluster 806, or a subcluster thereof, the adaptive test is administered 808. The adaptive test may be predetermined based on the cluster or may be generated based on the results of the screening test 802 and/or any sub-clustering, as previously discussed herein. In the example illustrated in FIG. 8, it is determined that the tested aptitude category test subjects 4, 5, and 16 are the tested aptitude category test subjects 816 with the greatest predictive value for examinees associated with cluster 1, and accordingly a test comprising questions to assess the examinee's scores associated with subjects 4, 5, and 16 is administered. It will be appreciated that, while the illustrated example shows an adaptive test that measures an examinee's aptitude in three tested aptitude category test subjects 816, a different number of tested aptitude category test subjects 816 may be tested, as discussed previously herein.

Once results are available for the adaptive test 808, predictive results are generated 810 for the remaining untested tested aptitude category test subjects. For instance, in the example illustrated in FIG. 8, test data has already been collected for all tested aptitude category test subjects 816 associated with the administered screening test 802 and adaptive test 808 (in the illustrated example, subjects 1, 4, 5, 7, 13, and 16) is used to predict results for the remaining tested aptitude category test subjects 816 (in the illustrated example, subjects 2, 3, 6, 8, 9, 10, 12, 12, 14, 15, 17, 18, 19, and 20).

Along with the predicted results, a confidence value in the accuracy of the predicted results is also generated. This confidence value is compared to a confidence value target to determine whether the predictions have been made with sufficient confidence to generate one or more vocational recommendations 812. If the confidence value is still too low, the next most relevant aptitude category test subjects will be identified 814 and tested, and the predictions of the remaining untested tested aptitude category test subjects will be recalculated, using the additional test data to improve the accuracy (and therefore the confidence value) of the predicted results.

When a set of predicted results with an acceptable confidence value is available, one or more vocational recommendations can be provided 818. The vocational recommendations can comprise fit scores for one or more career or educational pathways as discussed herein. The vocational recommendations can also take into consideration any of the other measurements and/or data discussed herein, including examinee interest scores, market data, educational certifications, local criteria, and additional examinee-reported aptitudes, as disclosed herein.

In As a natural output of its aptitude-based vocational guidance, one exemplary core system may produce standardized aptitude, interest, and overall fit scores or career fit scores for each career-user pair. Initial career fit calculations may for example be augmented to shorten aptitude measures, account for user demographic or other relevant data, and the like. An objective for various embodiments of analytic products as disclosed herein may further be to combine these standardized career fit scores with user demographic data and organization data in a variety of ways to create numerical program fit scores and other valuable analytics.

These analytics may generally be made available to, e.g., internal system staff, administrative users within the current system organization context, as well as other newly defined external users outside of the system organizational context (e.g., a technical college administrator).

In various embodiments, the analytic products may be implemented to provide one or more of the following features. A reliable, scalable analytics platform may be created for importing and managing the necessary career data fit scores, user data, and organization data from the existing system. The platform may define career associations, weights, and labeling programs to which the system would like to associate users based on aptitude and interest fit. The platform or process may calculate, and store, user level program fit scores based on career aptitude, interests, and overall fit scores and their respective importance weightings. The platform or process may define and assemble program fit scores, perform necessary ranking and presentation calculations, and assemble user and organization data for presentation purposes. A report and analytic delivery process may be created using multiple methods for delivery. An analytic user management process may be created that manages authentication and authorization to secure the system analytic and student data.

There are many potential uses of the system analytics, some of which are referenced or illustrated herein in non-limiting fashion, but one primary initial use may be to help students/users, counselors, CTE Directors, college administrators, employers and others compare the fit of users between various academic and work-study programs by transforming personalized career predictions and/or recommendations (e.g., career fit scores) into corresponding personalized program predictions and/or recommendations (e.g., program fit scores) based on system defined parameters correlating career elements to program elements. For example, the system can help students make more informed choices regarding which CTE Programs are best suited to their interests and talents. The system can also help counselors assign students more thoughtfully to a variety of internships within the academic or career-oriented programs within their own educational communities. The program can also help technical colleges, community colleges, or other secondary or higher education institutions best fit and identify students for certain technical and community college programs offered by that institution.

In each case, the student or the counselor must make choices between a set of seemingly heterogeneous programs. In an embodiment, calculating a program fit score for each program/user pair (derived from the career fit scores for the user) may allow analytic users to compare the programs under consideration based on a common numeric value that represents aptitude, interest, or overall fit of a student for each program. The system thus allows users to match students with programs best fit for the students' interests, talents, and aptitudes based on the results of the students' career assessments and career fit scores.

The presentation of the data to the report user may preferably vary depending on the use case. For example, a CTE director may want to place all of his/her students into one of the CTE programs offered at the local high school. Accordingly, the system can rank all of the available CTE programs for each student based on aptitude, interest, and overall fit. In contrast, technical and community college faculties, or the faculty of other higher education or vocational training institutions, may want to identify the highest fit students for the programs offered at their respective institutions rather than find a program for all students. As a result, the system may allow a user to identify or set a “cutoff” value for a generated report. The cutoff value can be based on a specified number or percentage of students with the highest program fit scores, or the cutoff value can be a specified “high fit” designation to identify all students with a minimum program fit score.

As discussed herein, a “program” may be any educational program, degree, class, training course, internship, CTE course, program of study, apprenticeships, majors, desired career or talent reports, etc., that may be defined based on a career or group of careers for which the system can calculate a program fit score. The system can define programs based on their use within the system, or based on the careers, career fit scores, and importance weightings defined within the system.

In an embodiment, programs may be defined by at least two basic components: associated careers and the importance weighting of each associated career for each program. An associated career can have a non-zero weighting co-efficient in a given program up to one hundred percent, and a non-associated career can have a weighting coefficient of zero. Some examples of programs which can be defined in the system can include, but are not limited to: individual careers used for talent pipeline analysis for employers; CTE pathways that vary from state to state; technical college programs; community college programs; university level career oriented programs such as computer science, education, or business; internships which may vary greatly depending on the specificity; apprenticeships which may be tailored to a particular employer; various career groupings used for career fairs; talent reporting used to help schools and districts better understand their student population; career cluster reporting that can be used by 8th-9th grade career coaches.

In some embodiments, the system can be designed to only allow designated administrative staff to define or create programs within the system, and further optionally to define program characteristics such as demographic data, as designated administrative staff may have an enhanced understanding of the system parameters, careers, etc., defined in the system which can aid the administrators create more specific and tailored programs for a user's needs. Having program creation functionality limited only to program administrators can also allow administrators to monitor and update the system in the event of duplicate or highly similar programs being created, which can help declutter the system and the available programs on the system. The system can include an administrator portal which can authenticate and authorize an administrator's access to program creation functionality within the system via a username and password or any other suitable authentication system. Administrators can receive program input or desired program parameters from users, which the administrators can then use to create a program within the system. In other embodiments, the system can also allow users to create their own programs.

In one example of such an embodiment, once the administrators log into the system administrative portal, they can access a tab within the system that contains the program management and creation functionality, wherein the administrative user can have the ability to create, duplicate, edit, and delete programs based on one or more parameters. The system can allow an administrative user to search the system for existing programs for a given organization or institution or other programs which may have similar attributes to or may be duplicates of the intended new program. The administrative user can search by a program number or partial number, a program name or partial name, a program type, country, state, school, institution, etc.

The administrative user can create a profile of the program within the system by using a series of pre-defined lists or criteria to indicate: program type; country affiliation; state affiliation if applicable (or indicate entire country); primary affiliation (could be a university, school district, etc.); secondary affiliation (could be a school, campus, employer, etc.); and careers associated with the program from a list of careers in the system. In some embodiments, a careers list within the system can include career codes or identifiers in addition to the career title, the list being sortable by either the career code or the title. In some embodiments, for each career selected for association with the program, the administrative user can enter a weighting in percentage terms. The weighting can range from 1% to 100%. The default can be 100%. The system can present the default percentage, so that the administrative can either accept the default or change it. The administrative user can name the new program using a free form field which can accept alphanumeric inputs. In some embodiments, the system database can include stored identifiers for various organizations of educational institutions, and the same organizational identifiers can be utilized in the titles for programs associated with that organization. The administrative user can then review the created program and modify any data prior to submission. The administrative user can then accept and create the program, wherein the program can be given a unique program number and stored in the system.

To edit a program, a system administrative user can search the system for an existing program using the program number, title, program type, or program country or state for that program. Once a program is selected, the administrative user can be given the option of editing any of the elements or information within the program profile in order to update that program. The administrative user can add or delete careers associated with a program, for instance in a situation where program parameters change. In the case of adding careers, the administrative user can pick from existing system careers and accept or modify the default weighting for that career as applicable. The administrative user can also modify an existing career in a program profile by changing its associated weighting. The system can prompt the administrative user to accept the changes to avoid unintended edits.

In some embodiments, the system can allow an administrative user to duplicate an existing program that is similar to an intended new program and edit the duplicate program to include information or parameters for the new program. To duplicate and edit a program, the administrative user can search the system for similar programs within the system, for instance by searching for other programs associated with a given organization, institution, or geographic region. The administrative user can be given the choice to duplicate a chosen program. Once duplicated, the system can immediately require the administrative user to rename the duplicated program. The administrative user can then edit program fields or parameters, including the careers associated with the new program and the weights for each career. Once the duplicate program is finalized, accepted, and submitted, the system will assign the duplicated and edited program a new program number.

Newly created programs may have similar attributes to or may essentially be a duplicate of an existing program. In such circumstances, the administrative user can be given the option to delete a program. This will remove the program from the system and make its name and number available for other use. Alternatively, the name and number of the deleted program can remain unavailable for new programs such that each program has a unique name and number even when compared to deleted programs. Before completing the delete task, the system can present the administrative user with a confirmation to complete the action with a warning that the entire program profile will be deleted and unavailable.

The system can establish a numbering and classification scheme for programs with a variety of suitable numbering or classification conventions or schema. One such classification convention can be the following: [program type] [country code] [state/province] [Institution/Descriptor 1] [Descriptor 2]; wherein the descriptors can vary from a college or institution name, campus name, technical field, degree type, etc. A practical example of the above convention can be the following: [Technical college] [U.S.] [GA] [Surgical Tech] [Associates Degree]. Many colleges, states, etc. will have their own numbers or designations for various academic programs. The system can allow these customer designations to be stored and associated with the system's own unique ID for a particular program. These customer designations may be used as outputs for display on certain types of reports generated by the system.

Each user in the system may be subject to hundreds of potential programs. For example, a single high student may be subject to 10-20 CTE programs, 200 programs from the local technical college, 150 programs from the local community college, 75 programs for 5 local employers looking for talent, and 30 programs from the local Chamber of Commerce evaluating the emerging talent pipeline. Program fit scores may also be volatile. A user's scaled career fit score contained in a calculation may change as they take option assessments, or the system changes its normative range for an aptitude within a career. The system may change the definitional profile of a program by adding, deleting, or changing the weighting of a career within the program profile. Finally, a user's relevance to a particular program may be quite temporary. For example, an employer may want to evaluate a student's fit for a particular internship. The internship may be available only to graduating seniors in the summer after high school graduation. Likewise, CTE programs are most relevant to students from 8^{th}-11^{th} grade. In either case, the time is only a fraction of the time the user may be active within the system.

Because of the large number of programs contemplated to be included in the system, and because of the large number of different potential permutations between each user or student or group of students and the programs stored in the system, the system can be designed not to automatically calculate and store personalized predictions and/or recommendations (e.g., program fit scores) in real time for each program/user pair as a general rule. Given the large number of potential program/user pairs, calculating in real time the program fit scores for all program/user pairs could require large amounts of computing power, storage, and bandwidth for the system, which could cause the system to fail or otherwise undesirably slow down functionality of the system. As such, the system can calculate program fit scores for specific program/user combinations as requested by a report user, such as a student user or a program or institution director or recruiter. However, standardized reports or scheduled reports can be identified within the system that can be scheduled to run as appropriate to provide a report to a report user at a specified time, such as daily, weekly, monthly, etc. In other embodiments, however, the program fit scores can be continuously calculated in real time to provide for quicker reporting functionality.

When generating reports, a user can filter within the system for a desired group of programs to determine program fit scores for a particular student, or the user can filter within the system for a desired group of students for which to calculate program fit scores for a single or group of programs.

For instance, a student can filter a listing of programs within the system by geographical area, technical discipline, interest area, etc., and generate a report of the student's program fit scores for each program selected so that the student can receive a ranking of the programs best fit for the student, the programs ranked by program fit score. Because each program weights certain careers associated with that program, a user may be better suited for one program over the other despite the fact that two programs on their face may look similar. For instance, two colleges may both offer electrical engineering programs, but one program focuses more on a particular discipline with the electrical engineering, such as power systems, while the other focuses more on another discipline within the electrical engineering field, such as circuit board design. A student who has stronger aptitude or interest in power systems versus circuit board design would have higher program fit score for the electrical engineering program for the first college compared to the second. The system thus allows students to potentially differentiate between two facially similar programs based on the student's interests and career fits.

In another example, a program director at a high school or other educational institution can filter within the system for profiles of students attending the director's institution and filter the programs within the system to the programs offered at the institution. The director can then generate a report either by student with the programs offered at the institution ranked by program fit scores for each student, or the director can generate a report by program with a rank of students by program fit scores for each program. The director can then use these reports to help optimize the pairing of students with available programs considering the available space in each program.

In another example, a recruiter or recruiting department at an educational institution can use the system to identify students within a desired geographical region, age, gender, high school, etc., and run a report of program fit scores for those students against programs offered at the educational institution. The system can generate a report including a student ranking for each program by program fit score, such that the recruiting department can use the report to be more deliberate in their recruiting efforts to recruit and market particular programs offered by the institution to students with higher program fit scores for those programs, as opposed to mass recruiting of an entire high school or region.

For each of the examples above, the user is able to filter within the system by student or user profile, by program, or a combination of both, to generate a report of program fit scores. The system only generates program fit scores for the program/user pairs selected by the user and only upon initiation or request of the report by the user. Such a filtering process can help reduce the computing requirements and other technical requirements associated with computing the program fit scores for all possible program/user combinations within the system in real time.

With such an independent reporting system, lag time between report requests and the delivery of the report can be minimized and, in some instances, performed in real time or maintained below a period of 2 hours. Some systems can also be configured to support 2000 or more users requesting reports concurrently or simultaneously and be capable of inputting up to five million or more new computed user profiles every year with calculated career fit scores and profile information.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of a new and useful invention, it is not intended that such references be construed as limitations upon the scope of this invention except as set forth in the following claims.

What is claimed is:

1. A predictive method for matching users to careers and/or career groupings,
the method comprising, during a model training stage:
collecting training input data comprising, for each of a plurality of training users, a plurality of aptitude testing performance values, and user input corresponding to interest values for one or more of a plurality of careers; and
training one or more neural network-based models to generate clusters of the input data, including at least aptitude testing performance value combinations, which correlate to respective careers, wherein training parameters are selected for each combination corresponding to a respective number of aptitude testing performance values and a respective degree of correlation; and
the method comprising, during a current user assessment stage:
collecting current input data comprising, for a current user, a plurality of aptitude testing performance values for a corresponding first set of aptitude tests, and current user input corresponding to interest values for one or more of the plurality of careers;
by reference to the trained model, identifying a cluster of training input data corresponding to similarly performing training users with respect to the collected current input data, and selecting a second set of aptitude tests based on a predicted combination of aptitude tests optimizing a minimal number of aptitude testing performance values and/or maximizing a respective degree of correlation to respective careers;
collecting further current input data comprising, for the current user, aptitude testing performance values for the corresponding second set of aptitude tests, and generating an aggregate set of aptitude testing performance values; and
generating a user-specific data set representing correlations for the collected current input data and further current input data with respect to one or more of the plurality of careers.

2. The method of claim 1, further comprising, during the current user assessment stage and upon identifying a first cluster of training input data corresponding to similarly performing training users with respect to the collected current input data, further identifying a second cluster of training input data for micro-segmentation within the first cluster, and selecting the second set of aptitude tests based at least in part on modeled correlations associated with the identified second cluster.

3. The method of claim 1, comprising determining whether to recluster the current user based on the further current input data and a fit of the further current input data with respect to predicted further current input data based on historical data for training users in the same cluster as the current user.

4. The method of claim 1, comprising monitoring demographic data for the current user, and dynamically determining over time whether to recluster the current user based on changes in the demographic data.

5. The method of claim 1, further comprising, during the current user assessment stage and upon generating the aggregate set of aptitude testing performance values, predicting aptitude performance values for the current user with respect to one or more untested aptitudes, based at least in part on historical aptitude testing performance values for training users in the same cluster as the current user, wherein the generated aggregate set of aptitude testing performance values comprises the predicted aptitude performance values.

6. The method of claim 1, wherein demographic data is obtained for the current user, the method further comprising dynamically determining over time whether to regenerate the user-specific data set based on changes in the demographic data.

7. The method of claim 1, comprising training at least one of the one or more neural network-based models to correlate pathways with respect to careers, and further generating the user-specific data set to represent correlations to one or more pathways with respect to the one or more of the plurality of careers, based at least in part on current user-specific demographic data and pathway-specific demographic data.

8. The method of claim 1, wherein at least the collected current input data and the further current input data associated with the current user are provided for model feedback as another training user.

9. The method of claim 8, comprising dynamically obtaining career-based feedback associated with one or more of the training users over time, and iteratively training the model to generate the clusters further accounting for the career-based feedback.

10. The method of claim 1, wherein the second set of aptitude tests is selected based at least in part on a specified maximum number of aptitude tests or a specified maximum amount of test time for obtaining the aptitude testing performance values.

11. A system for predictive matching of users to careers and/or career groupings, the system comprising one or more processors associated with one or more computing devices and configured to direct the performance of:
during a model training stage:
collecting training input data comprising, for each of a plurality of training users, a plurality of aptitude testing performance values, and user input corresponding to interest values for one or more of a plurality of careers; and
training one or more neural network-based models to generate clusters of the input data, including at least aptitude testing performance value combinations, which correlate to respective careers, wherein training parameters are selected for each combination corresponding to a respective number of aptitude testing performance values and a respective degree of correlation; and
during a current user assessment stage:
collecting current input data comprising, for a current user, a plurality of aptitude testing performance values for a corresponding first set of aptitude tests, and current user input corresponding to interest values for one or more of the plurality of careers;
by reference to the trained model, identifying a cluster of training input data corresponding to similarly performing training users with respect to the collected current input data, and selecting a second set of aptitude tests based on a predicted combination of aptitude tests optimizing a minimal number of aptitude testing performance values and/or maximizing a respective degree of correlation to respective careers;
collecting further current input data comprising, for the current user, aptitude testing performance values for the corresponding second set of aptitude tests, and generating an aggregate set of aptitude testing performance values; and
generating a user-specific data set representing correlations for the collected current input data and further current input data with respect to one or more of the plurality of careers.

12. The system of claim 11, wherein the one or more processors are further configured to direct the performance of, during the current user assessment stage and upon identifying a first cluster of training input data corresponding to similarly performing training users with respect to the collected current input data, further identifying a second cluster of training input data for micro-segmentation within the first cluster, and selecting the second set of aptitude tests based at least in part on modeled correlations associated with the identified second cluster.

13. The system of claim 11, wherein the one or more processors are further configured to direct the performance of determining whether to recluster the current user based on the further current input data and a fit of the further current input data with respect to predicted further current input data based on historical data for training users in the same cluster as the current user.

14. The system of claim 11, wherein the one or more processors are further configured to direct the performance of monitoring demographic data for the current user, and dynamically determining over time whether to recluster the current user based on changes in the demographic data.

15. The system of claim 11, wherein the one or more processors are further configured to direct the performance of, during the current user assessment stage and upon generating the aggregate set of aptitude testing performance values, predicting aptitude performance values for the current user with respect to one or more untested aptitudes, based at least in part on historical aptitude testing performance values for training users in the same cluster as the current user, wherein the generated aggregate set of aptitude testing performance values comprises the predicted aptitude performance values.

16. The system of claim 11, wherein demographic data is obtained for the current user, wherein the one or more processors are further configured to direct the performance of dynamically determining over time whether to regenerate the user-specific data set based on changes in the demographic data.

17. The system of claim 11, wherein the one or more processors are further configured to direct the performance of training at least one of the one or more neural network-based models to correlate pathways with respect to careers, and further generating the user-specific data set to represent correlations to one or more pathways with respect to the one or more of the plurality of careers, based at least in part on current user-specific demographic data and pathway-specific demographic data.

18. The system of claim 11, wherein at least the collected current input data and the further current input data associated with the current user are provided for model feedback as another training user.

19. The system of claim 18, wherein the one or more processors are further configured to direct the performance of dynamically obtaining career-based feedback associated with one or more of the training users over time, and iteratively training the model to generate the clusters further accounting for the career-based feedback.

20. The system of claim 11, wherein the second set of aptitude tests is selected based at least in part on a specified maximum number of aptitude tests or a specified maximum amount of test time for obtaining the aptitude testing performance values.
